(19) United States
(12) Patent Application Publication
(10) Pub. No.: US 2026/0023989 A1
(43) Pub. Date: Jan. 22, 2026

(54) GRADUAL JOINED INFERENCE DURING AI MODEL DOWNLOADING

(71) Applicant: HUAWEI TECHNOLOGIES CO., LTD., SHENZHEN (CN)

(72) Inventors: Seyedeh Maryam HOSSEINI, Kanata (CA); Hesham Gamal Aly Mohamed MOUSSA, Kanata (CA)

(73) Assignee: HUAWEI TECHNOLOGIES CO., LTD., SHENZHEN (CN)

(21) Appl. No.: 18/778,209

(22) Filed: Jul. 19, 2024

(51) Int. Cl. G06N 5/04

(52) U.S. Cl. CPC G06N 5/04

(57) ABSTRACT

A method and apparatus for gradual inference during continuous deployment of a replacement IA model replacing a current AI model is provided. Replacement blocks of the replacement AI model are provided to the computing device by an AI model provider directly or via one or more network element associated therewith to replace the current AI model. A computing device having the current AI model gradually receives replacement blocks and in response, deletes current blocks of the current AI model. Inference request can be processed gradually at the computing device as soon as at least the first replacement block is received thereat using received sequential replacement blocks to obtain a partial inference that is subsequently jointly processed at the AI model provider or one or more network element associated therewith to obtain an inference result, thereby enabling access to the replacement AI model for inference during its download at the computing device.

### CROSS-REFERENCE TO RELATED APPLICATIONS

This is the first application filed for the present disclosure.

### FIELD OF THE INVENTION

The present disclosure pertains to the field of artificial intelligence (AI), and in particular to methods and systems for continuous deployment of AI models.

### BACKGROUND

Upgrading an AI model at a user device may require reserving storage space for the complete upgraded AI model in addition to storage space already occupied at the user device by a current AI model. With increasing complexity and capabilities of AI models, storage required at the user device may increase correspondingly.

The user device may need to keep a substantial amount of storage reserved for upgrading an AI model that may adversely impact other device functions. Typically, an upgraded AI model may be used by the user device only after complete download and deployment thereof to the user device, thereby delaying availability of the upgraded AI model functionalities to the user. Additionally, the unavailability of the upgraded AI model for inference until it is fully downloaded and deployed at the user device, necessitates using the current AI model for inference until completion of the upgrade, which can potentially introduce reliability or accuracy issues.

Therefore, there is a need for systems and methods for inference during AI model download that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

One or more aspects of disclosure provides for systems and methods for inference during an AI model download.

An aspect of the present disclosure provides a method that includes obtaining, at a computing device having stored thereat a current artificial intelligence (AI) model having a sequence of current blocks stored in a memory coupled to the computing device, from an AI model provider having a replacement AI model that includes a sequence of replacement blocks, a set of replacement blocks from among the sequence of replacement blocks. The set of replacement blocks has one or more replacement block. The method includes, at the computing device, storing the set of replacement blocks in the memory and deleting from the memory at least one current block. The method includes, at the computing device, obtaining an inference request, processing the inference request using the set of replacement blocks to obtain a partial inference, and providing the partial inference to the AI model provider.

According to aspects of the present disclosure, continuous deployment of a replacement AI model is provided. Replacement blocks of the replacement AI model may be provided to the computing device directly or via one or more network element associated therewith to replace a current AI model at the computing device. As the computing device receives replacement blocks, the computing device may begin deleting current blocks of the current AI model that are being replaced, thereby reducing storage space requirements at the computing device during download of the replacement AI model. An inference request can begin to be processed at the computing device as soon as at least the first replacement block is received at the computing device by using received sequential replacement blocks to obtain a partial inference, which can be subsequently processed at the AI model provider or one or more network element associated therewith to obtain an inference result. This enables access to the replacement AI model for inference during its download at the computing device, before the replacement AI model is completely downloaded.

According to the aspect in the present disclosure, in a possible design, the method may include obtaining from the AI model provider the inference result obtained by processing the partial inference using a group of remaining replacement blocks comprising all the replacement blocks of the sequence of replacement blocks that are not part of the set of replacement blocks.

According to the aspect in the present disclosure, in a possible design, the AI model provider may include a network element associated therewith, such as a base station (BS), having access to the sequence of replacement blocks. Providing the partial inference to the AI model provider may include providing the partial inference to the network element, such as the BS. The network element, such as the BS, may have a group of remaining replacement blocks, the remaining replacement blocks comprising all the replacement blocks of the sequence of replacement blocks that are not part of the set of replacement blocks, and the method may further include the network element, such as the BS, computing the inference result using the group of remaining replacement blocks.

According to the aspect in the present disclosure, in a possible design, all the replacement blocks of the sequence of replacement blocks that are not part of the set of replacement blocks forming a group of remaining replacement blocks having one or more remaining replacement block.

According to the aspect in the present disclosure, in a possible design, the network element, such as the BS, may be a first network element, such as a first BS, and the AI model provider may include a second network element, such as a second BS, having access to the sequence of replacement blocks. Obtaining, from the AI model provider, the set of replacement blocks may include obtaining the set of replacement blocks from the first network element, such as the first BS, and providing the partial inference to the AI model provider may include providing the partial inference to the second network element, such as the second BS, for processing the partial inference using the group of remaining replacement blocks to obtain the inference result.

According to the aspect in the present disclosure, in a possible design, the sequence of current blocks may include a current input block, and obtaining, at the computing device, the set of replacement blocks may include obtaining a replacement input block to replace the current input block.

According to the aspect in the present disclosure, in a possible design, the method may include deleting, from the memory, the sequence of current blocks of the current AI model.

According to the aspect in the present disclosure, in a possible design, the method may include obtaining, at the computing device, a group of remaining replacement blocks of the replacement AI model, the group of remaining replacement blocks comprising all the replacement blocks of the sequence of replacement blocks that are not part of the set of replacement blocks, and processing, at the computing device, a further inference request using the set of replacement blocks and the group of remaining replacement blocks of the replacement AI model to obtain a further inference result to the further inference request.

According to the aspect in the present disclosure, in a possible design, the method may include one or more of: receiving, at the computing device, from the AI model provider, an indication of the replacement AI model; and providing, by the computing device to the AI model provider, based on the indication, a request requesting the replacement AI model.

According to the aspect in the present disclosure, in a possible design, the computing device may be one of: an edge device, a physical computing device, a virtual computing device, a target agent, an end user device, or a combination thereof, and obtaining, at the computing device, the inference request may include obtaining the inference request at, respectively, the edge device, the physical computing device, the virtual computing device, the target agent, the end user device, or the combination thereof.

According to the aspect in the present disclosure, in a possible design, the AI model provider may be one of: a network element, a base station (BS), a datacenter, an AI model providing service, an AI model training factory, another edge device, another physical computing device, another virtual computing device, another target agent, another end user device, or a combination thereof; and providing the partial inference to the AI model provider may include providing the partial inference to, respectively, the network element, the base station (BS), the datacenter, the AI model providing service, the AI model training factory, the other edge device, the other physical computing device, the other virtual computing device, the other target agent, the other end user device, or the combination thereof.

According to the aspect in the present disclosure, in a possible design, the replacement AI model may be one of: an updated version of the current AI model, a new AI model for replacing the current AI model, or a copy of the current AI model for replacing an unusable copy of the current AI model.

Another aspect of the present disclosure provides a method of providing, by an AI model provider having a replacement AI model that includes a sequence of replacement blocks, a set of replacement blocks from among the sequence of replacement blocks to a computing device having stored thereat a current AI model having a sequence of current blocks stored in a memory coupled to the computing device. The set of replacement blocks has one or more replacement block, all the replacement blocks of the sequence of replacement blocks that are not part of the set of replacement blocks forming a group of remaining replacement blocks having one or more remaining replacement block. The method further includes obtaining, by the AI model provider from the computing device, a partial inference based on the set of replacement blocks, and processing the partial inference using the group of remaining replacement blocks, to obtain an inference result. The method may include the AI model provider providing the inference result to the computing device.

According to the aspect in the present disclosure, in a possible design, the partial inference may be obtained at the computing device by processing an inference request using the set of replacement blocks. The computing device may be configured to store the set of replacement blocks in the memory and delete from the memory at least one current block.

According to the aspect in the present disclosure, in a possible design, the AI model provider may include a network element, such as a BS, having access to the sequence of replacement blocks, and obtaining, from the computing device, by the AI model provider may include obtaining, by the network element, such as the BS, the partial inference. The network element, such as the BS, may have the group of remaining replacement blocks, and the method may include the network element, such as the BS, computing the inference result using the group of remaining replacement blocks.

According to the aspect in the present disclosure, in a possible design, the network element, such as the BS, may be a first network element, such as a first BS, and the AI model provider may include a second network element, such as a second BS, having access to the sequence of replacement blocks. Providing, by the AI model provider, the set of replacement blocks may include the first network element, such as the first BS, providing the set of replacement blocks. Obtaining the partial inference by the AI model provider may include receiving, by the second network element, such as the second BS, the partial inference for processing the partial inference using the group of remaining replacement blocks to obtain the inference result.

According to the aspect in the present disclosure, in a possible design, the sequence of current blocks may include a current input block, and providing, by the AI model provider, the set of replacement blocks may include providing a replacement input block to replace the current input block.

According to the aspect in the present disclosure, in a possible design, the method may include providing, by the AI model provider to the computing device, the group of remaining replacement blocks of the replacement AI model.

Another aspect of the present disclosure provides a system that includes a computing device having stored thereat a current AI model having a sequence of current blocks stored in a memory coupled to the computing device, and an AI model provider having a replacement AI model that includes a sequence of replacement blocks. The AI model provider is configured to provide a set of replacement blocks from among the sequence of replacement blocks to the computing device, the set of replacement blocks having one or more replacement block, all the replacement blocks of the sequence of replacement blocks that are not part of the set of replacement blocks forming a group of remaining replacement blocks having one or more remaining replacement block. The AI model provider is configured to obtain, from the computing device, a partial inference obtained by processing an inference request at the computing device using the set of replacement blocks, and process the partial inference using the group of remaining replacement blocks, to obtain an inference result.

According to the aspect in the present disclosure, in a possible design, the AI model provider may further include a network element, such as BS, having access to the sequence of replacement blocks, and providing the partial inference to the AI model provider may include providing the partial inference to the network element, such as the BS.

According to the aspect in the present disclosure, in a possible design, at any time, a size of the memory occupied by the received set of replacement blocks of the replacement AI model and all current blocks of the current AI model remaining in the memory, is less than a combined total size of a size of the sequence of replacement blocks of the replacement AI model and a size of the sequence of current blocks of the current AI model.

According to an aspect, a computer-readable storage medium is described. The computer-readable storage medium stores computer-readable instructions, and when a computer reads and executes the computer-readable instructions, the computer is enabled to perform the method in any one of the possible designs provided by the above aspects.

According to an aspect, this application provides a computer program product. When a computer reads and executes the computer program product, the computer is enabled to perform the method in any one of the possible designs provided by the above aspects.

According to an aspect, this application provides a method performed by a system comprising at least one of an apparatus in (or at) a computing device of the present application, and an apparatus in (or at) an AI model provider of the present application.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 shows a schematic illustration of a network, according to embodiments of the present disclosure.

FIG. 2 shows a flowchart of a method for inference during download of a replacement AI model, according to an embodiment of the present disclosure.

FIG. 3 shows a flowchart of a method for inference during download of replacement AI model blocks one at a time, according to an embodiment of the present disclosure.

FIG. 4 shows a flowchart of a method for inference during download of different AI model replacement blocks from different network elements, according to an embodiment of the present disclosure.

FIG. 5 shows a flowchart of a method for inference during download of a replacement AI model to a moveable computing device, according to an embodiment of the present disclosure.

FIG. 6 shows a schematic illustration of an electronic device that may perform any or all of operations of the methods and features explicitly or implicitly described herein, according to embodiments of the present disclosure.

It will be noted that throughout the appended drawings, like features are identified by like reference numerals.

### DETAILED DESCRIPTION

The present disclosure provides a method for continuous deployment of a replacement artificial intelligence (AI) model that includes a sequence of replacement blocks, at a computing device having a current AI model that includes a sequence of current blocks. The replacement blocks are provided to the computing device by an AI model provider directly or via one or more network element associated therewith to replace current AI model. As the computing device begins gradually receiving replacement blocks, it begins deleting current blocks of the current AI model, thereby reducing storage space requirements at the computing device during download of the replacement AI model. Inference request can be processed gradually at the computing device as soon as at least the first replacement block is received thereat using received sequential replacement blocks to obtain a partial inference that is subsequently jointly processed at the AI model provider or one or more network element associated therewith to obtain an inference result, thereby enabling access to the replacement AI model for inference during its download at the computing device.

That is, the present disclosure allows for a smooth transition from an old artificial intelligence (AI) model to a replacement AI model on a computing device. The replacement AI model is made up of replacement blocks, which gradually replaced the old ones as they're downloaded onto the device. This process reduces the amount of storage space needed on the device while the replacement AI model is being installed. As the replacement blocks are received, the computing device may start deleting the old blocks from the old AI model, freeing up space. When a request for an answer or decision (called an inference) is made, the device can start processing it using the replacement blocks that have been received so far. The remaining parts of the inference are then completed at the AI model provider or with the help of other network elements, allowing users to access the new AI model and get answers during the download process.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The phrase “in embodiments” can be interpreted to mean “in one or more, but not necessarily all embodiments.”

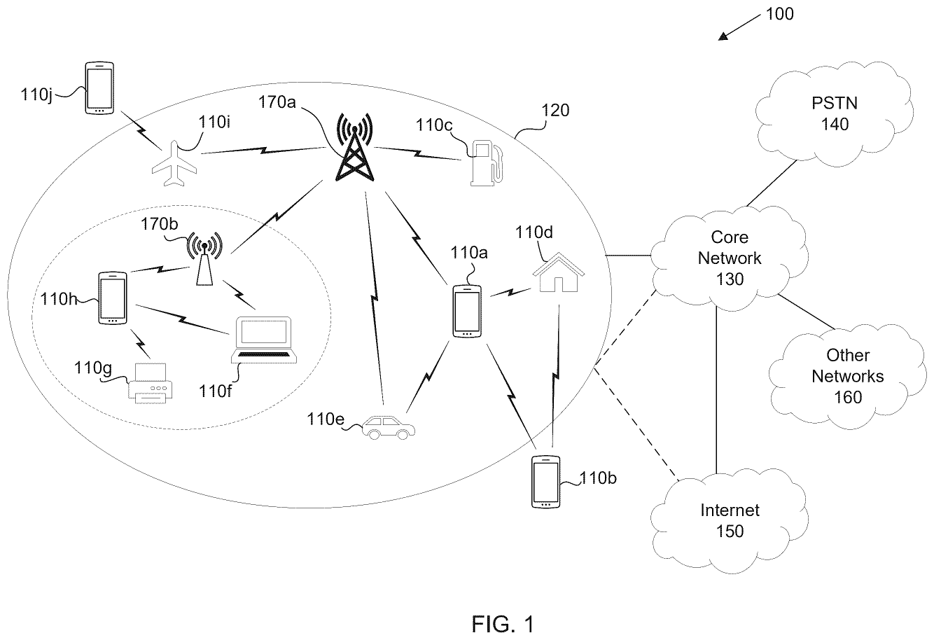

FIG. 1 schematically illustrates a communication network 100, according to embodiments. The communication network 100 may include an underlay network, such as a transport network. The communication network 100 may include an overlay network, such as a mobile network. The communication network 100 may include an application-driven network. The communication network 100 may include a radio access network (RAN) 120. The RAN 120 may be a next generation (e.g., 6th generation (6G) or later) radio access network, or a legacy (e.g., 5th generation (5G), 4th generation (4G), 3rd generation (3G) or 2nd generation (2G)) radio access network. In some implementations, the 6G radio access refers to a next generation air interface of standards which may comprise both terrestrial networks (TNs) and non-terrestrial networks (NTNs). The communication network 100 may include a core network (CN) 130 that may be dependent or independent of the radio access technology used in the network. The communication network 100 may include a public switched telephone network (PSTN) 140, the internet 150, and other networks 160. In general, the communication network 100 enables communication of multiple wireless or wired nodes thereof. One or more nodes 110a, 110b, 110c, 110d, 110c, 110f, 110g, 110h, 110i, 110j may be interconnected to one another and/or connected to one or more network elements 170a, 170b, such as base stations, aquatic stations, aerial stations, or ground stations, in the RAN 120.

The communication network 100 may provide content, such as voice, data, video, and/or text, via broadcast, multicast, groupcast, unicast, etc. The communication network 100 may operate by sharing resources, such as carrier spectrum bandwidth, among its constituent elements. The communication network 100 may provide a wide range of communication services and applications to network users including enhanced Mobile Broadband (eMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication, and other services that can be provided by a future generation communication system. The communication network 100 may provide other services and applications such as earth monitoring, remote sensing, passive sensing and positioning, navigation and tracking, autonomous delivery and mobility, etc.

The communication network 100 may include a terrestrial network and/or a non-terrestrial network. The communication network 100 may provide a high degree of availability and robustness through a joint operation of a terrestrial network and a non-terrestrial network. For example, integrating a non-terrestrial network (or components thereof) into a terrestrial network can result in a heterogeneous network comprising multiple blocks. The heterogeneous network may achieve better overall performance through efficient multi-link joint operation, more flexible functionality sharing, and faster physical block link switching between terrestrial networks and non-terrestrial networks. The terrestrial network and the non-terrestrial network could be considered sub-systems of the communication network 100.

The communication network 100 may be compliant with one or more regional, national and/or international standard, such as the Internet Engineering Task Force (IETF), the European Telecommunications Standards Institute (ETSI™), and the 3rd Generation Partnership Project (3GPP™).

In embodiments, an AI model provider has, or has access to, a replacement AI model that includes a sequence of replacement blocks. A computing device has stored thereat a current AI model having a sequence of current blocks stored in a memory coupled to the computing device.

In embodiments, an AI model (i.e., replacement AI model, current AI model) may be any type of an AI model or any other machine learning model that has a number of blocks that are, at least in part, sequential. Blocks may, although not necessarily, at least in part, correspond to layers of an AI model, for example. A block, as used herein, refers to a segment or a portion of an AI model that can receive input (e.g., inference request, an output from a preceding block that is a partial inference), process the input, and produce an output that in a partial inference, as described elsewhere herein, that can be provided to another entity (e.g., computing device, AI model provider or any associated network element thereof) for further processing using at least one subsequent block available thereto or thereat. Blocks may be inherent in the AI model, for example when corresponding to layers of the AI model. Blocks may be assigned to the AI model, for example by the AI model provider.

A computing device, e.g. a device configured to perform computational tasks (for example, the may be a user equipment), running an AI model (i.e., replacement AI model, current AI model) and that obtains (e.g., receives) an inference request causes the AI model to obtain, at the AI model's input block, inference request including input data or features of the input data. The inference request and inference input are suitable (e.g., compatible, processable) for being received by the first or input replacement block of the replacement AI model. The input block processes the inference request and provides the processed input to the next block of the AI model, and so on, until the last or output block of the AI model outputs the inference that was requested. The output of the AI model at blocks other than output block is referred to herein as a partial inference. Blocks of an AI model may include one or more of hidden blocks, convolutional blocks, pooling blocks, recurrent blocks, batch normalization blocks, dropout blocks, dense blocks, and combinations thereof.

In some implementations, processing an inference request includes processing an inference input (e.g., input data or features of the input data, parameters of the request) of the inference request.

In embodiments, a replacement AI model may be an updated version of the current AI model, a new AI model (e.g., of a same or different type) for replacing the current AI model, a copy of the current AI model for replacing an unusable copy of the current AI model, a previous version of the current AI model (e.g., if the current version is recalled), or a combination thereof. The replacement AI model may, although not necessarily, have a same functionality and be of a same type as the current AI model. The current AI model at the computing device may be unusable, for example as a result of a model error, a system error, a model corruption, a security incident, a partial deletion, etc., that results in the current AI model being unable to an inference request (e.g., inference input thereof) to obtain an inference result that meets one or more predefined inference matric value. Non-limiting examples of an inference metric include an accuracy metric, a precision metric, a recall metric, a sensitivity metric, a hit-rate matric, an F1 score, a regression metric, a confusion matrix metric, a perplexity metric, a BLEU score metric, an area under receiver operating characteristics curve (AUROC) metric, and combinations thereof.

In embodiments, the replacement AI model replaces the current AI model at the computing device. At least one current block of the current AI model is deleted from the computing device (e.g., memory, storage thereof) in response to receiving an indication indicating the computing device is about to begin receiving the replacement AI model, receiving or beginning to receive at least one (e.g., first) replacement block, or a combination thereof. In some embodiments, all current blocks of the sequence of current blocks may be deleted from (e.g., memory coupled to, storage of) the computing device.

In some embodiments, the replacement AI model may replace the current AI model at the computing device substantially synchronously with the download of the replacement AI model at the computing device, e.g. one block at a time. For example, receiving a first block of the replacement AI model at the computing device may initiate deletion of a first block of the current AI model from the computing device, receiving a second block of the replacement AI model at the computing device may initiate deletion of a second block of the current AI model from the computing device, and so on until all blocks of the replacement AI model are received. In some cases, blocks of replacement AI model may be received non-sequentially (e.g., when being received from two or more network elements each having a corresponding subset of the blocks of the replacement AI model) and corresponding blocks of the current AI model may be removed non-sequentially. If, after all blocks of the replacement AI model are received at the computing device, one or more block of the current AI model remains at the computing device (e.g., number of replacement blocks is less than number of current blocks), the latter may be removed from the computing device. Such gradual removal may be implemented, for example, in scenarios where the current AI model may still be needed. For example, if the blocks of the replacement AI model correspond with blocks of the current AI model (e.g., the replacement AI model is an updated version of the current AI model and has the same number of blocks as the current AI model), inference may be possible using replacement blocks of the replacement AI model that have been obtained at the computing device and using the remaining blocks of the current AI model at the computing device to obtain inference result. For example, a computing device having received blocks 1-5 of blocks 1-N of the replacement AI model and having thereat at least blocks 6-N of a current AI model that is an earlier (e.g., outdated) version of the replacement AI model, in some cases may be able to obtain inference result to an inference request by processing the inference request using blocks 1-5 of the replacement AI model at the computing device to obtain a partial inference, and subsequently process the partial inference at the computing device using blocks 6-N of the current AI model to obtain the inference result. Such split processing of blocks among the replacement and current AI model blocks may be appropriate, for example when the computing device requires inference if the connection between the computing device and the AI model provider (or any applicable network element associated therewith) is interrupted or unavailable (e.g., network outage, bandwidth too low, network error, computing device moved out of communication range of associated network element/AI model provider, etc.)

In some embodiments, the removal of the current AI model may begin before receiving any blocks of the replacement AI model, for example, in response to the computing device determining, directly or by receiving or obtaining a corresponding indication from an AI model provider or an associated network element thereof, that the current AI model is not usable (e.g., corrupt, compromised).

In other embodiments, receiving a first block of the replacement AI model at the computing device may initiate removal of all blocks of the current AI model. Such removal may be implemented, for example, in scenarios where the current AI model or any blocks thereof are not compatible with the replacement blocks (e.g., deemed unusable, incompatible with or do not correspond to the replacement AI model and blocks thereof), and therefore will not be needed.

In some embodiments, the number of current blocks of the current AI model to be removed from the computing device in response to receiving one or more block of the replacement AI model, or an indication of a download thereof, at the computing device, may be determined in accordance with a size of such one or more replacement block. For example, the (e.g., indicated, estimated, approximate) size of one or more block of the replacement AI model received (i.e., already received or downloaded), being received (i.e., in the process of being received or downloaded) or to be received (e.g., computing device receives an indication of a size of one or more block of the replacement AI model to be received or downloaded) may correspond to a corresponding size of one or more blocks of the current AI model to be removed from the computing device. The removal of the current AI model from the computing device may be substantially simultaneous to the reception or download of the replacement AI model to the computing device, thereby limiting the required combined (i.e., overall, total) size of storage space at the computing device occupied at any time by all of the one or more current blocks of the current AI model and all of the one or more replacement blocks of the replacement AI model.

In embodiments, the storage space or size (of e.g., memory, physical storage, cache, virtual storage, cloud storage, etc.) occupied at the computing device by the received (e.g., set of) replacement blocks of the replacement AI model and all remaining current blocks of the current AI model is less than a combined total size of a size of the sequence of replacement blocks of the replacement AI model and a size of the sequence of current blocks of the current AI model. Thereby, at any time during receiving or downloading of the replacement AI model at the computing device, the space occupied at the computing device by the blocks of replacement AI model and the blocks of current AI model is less than the combined total size of both AI models (e.g., blocks thereof).

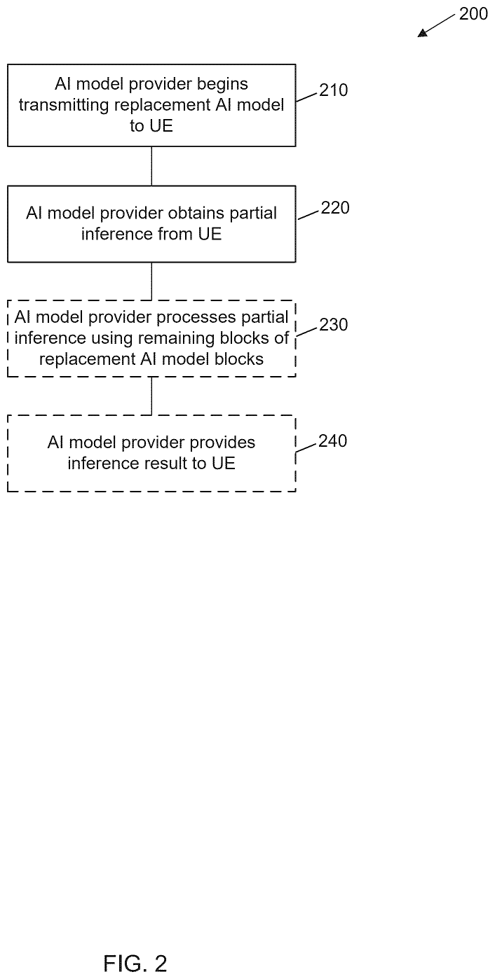

FIG. 2 shows a flowchart of an embodiment of a method 200 for inference during the provision or download of a replacement AI model at a computing device, in accordance with the present disclosure. The method 200 includes step 210 of beginning transmission of the replacement AI model by an AI model provider to a computing device. The transmission of step 210 begins with transmitting a first block of the replacement AI model. The method 200 includes step 220 of obtaining, by the AI model provider from the computing device, a partial inference obtained by processing an inference request at the computing device using received set of blocks of the replacement AI model, the set including one or more blocks including the first block of the replacement AI model. The method 200 may include step 230 of processing, at the AI model provider, the partial inference using a remaining group of blocks of the replacement AI model subsequent to the set of blocks used to obtain the partial inference at the computing device. The method 200 may include step 240 of the AI model provider providing the inference output to the computing device.

In embodiments, the AI model provider and any network elements associated therewith may be configured to provide an indication of the replacement AI model to the computing device. Conversely, the computing device may be configured to obtain (e.g., receive) such indication from the AI model provider. The indication may be indicative of one or more of: the replacement AI model being available for obtaining by the computing device, a size of the replacement AI model or one or more block thereof. The indication may request a confirmation from the computing device in response to the indication before beginning providing the replacement AI model to the computing device.

In embodiments, the computing device may be configured to provide to the AI model provider a request requesting the replacement AI model. Conversely, the AI model provider may be configured to receive or obtain such request from the computing device. The request may include an indication of the current AI model, in which case the AI model provider may respond to the request by providing the replacement AI model that is same as (e.g., same version of), a previous version of, or an updated version of the current AI model at the computing device, or by indicating to the computing device if such a replacement AI model is available. The request may be a query querying the AI model provider for the replacement AI model or an availability thereof for replacing the current AI model at the computing device.

The request, the indication, or both, as described above, may be provided and/or obtained as needed, for example in response to the current AI model being unusable or unavailable at the computing device. Additionally or alternatively, the request, the indication, or both, as described above, may be provided and/or obtained at predefined intervals, such as regular update intervals.

In embodiments, the computing device is an entity requiring inference and is in communication with the network, having a current AI model thereat (e.g., at one or more processor, one or more memory storage, one or more physical storage, one or more virtual storage, one or more cache storage, and/or one or more remote storage of computing device) or associated therewith. The computing device may be a physical computing device, a UE, a virtual computing device, a cloud computing device, an end user device, a target agent, an edge device, or a combination thereof.

In embodiments, the AI model provider provides a replacement AI model to a computing device. Or conversely, the computing device obtains the replacement AI model from the AI model provider. The AI model provider may be or may include one or more of: an AI model providing service, an AI model providing database (e.g., an application or AI model store), a base station (BS) or multiple BSs that have the AI model available thereat or are communicatively coupled with the AI model provider, an AI model providing application, a system administrator, an application administrator, an inference service, a datacenter, a server, an AI model training factory, another edge device (i.e., vs the computing device that may be an edge device), another physical computing device (i.e., vs the computing device that may be physical computing device), another virtual computing device (i.e., vs the computing device that may be virtual computing device), another target agent (i.e., vs the computing device that may be a target agent), another end user device (i.e., vs the computing device that may be an end user device), or a combination thereof; or any other entity having an AI model to be provided to the computing device, or a combination thereof.

Replacement AI model blocks may be provided to the computing device sequentially, beginning, for example with the first block. Providing the first block of the replacement AI model enables processing of the data and/or features of the inference input of the inference request when an inference request is obtained at the computing device, thereby facilitating privacy protection of the input.

In embodiments, an AI model provider may provide the replacement AI model directly to the computing device, indirectly to the computing device via one or more network element, or a combination thereof. Non-limiting examples of a network element include a station, an aquatic station, an aerial station, a ground station, a BS, a Next Generation Node B (gNB), and a server.

The AI model provider may include or be communicatively coupled to one or more network element. A network element may have access to some or all blocks of the replacement AI model. A network element may have access to or may have some (e.g., one or more block of a group of replacement blocks absent from the set of replacement blocks at the UE) or all of blocks of the replacement AI model thereat. The group of (i.e., remaining) replacement blocks include one or more replacement block. A network element be configured to receive an output (i.e., respective partial inference) of a sept of replacement blocks including one or more block of the replacement AI model from the computing device, the AI model provider and/or from another network element, process the received partial inference thereat using subsequent sequential blocks of the replacement AI model available thereat or accessible thereto (e.g., one or more block of a group of replacement blocks absent from the set of replacement blocks at the UE), and provide a respective output (i.e., that may be an inference result) of such processing to the computing device, the AI model provider and/or another network element.

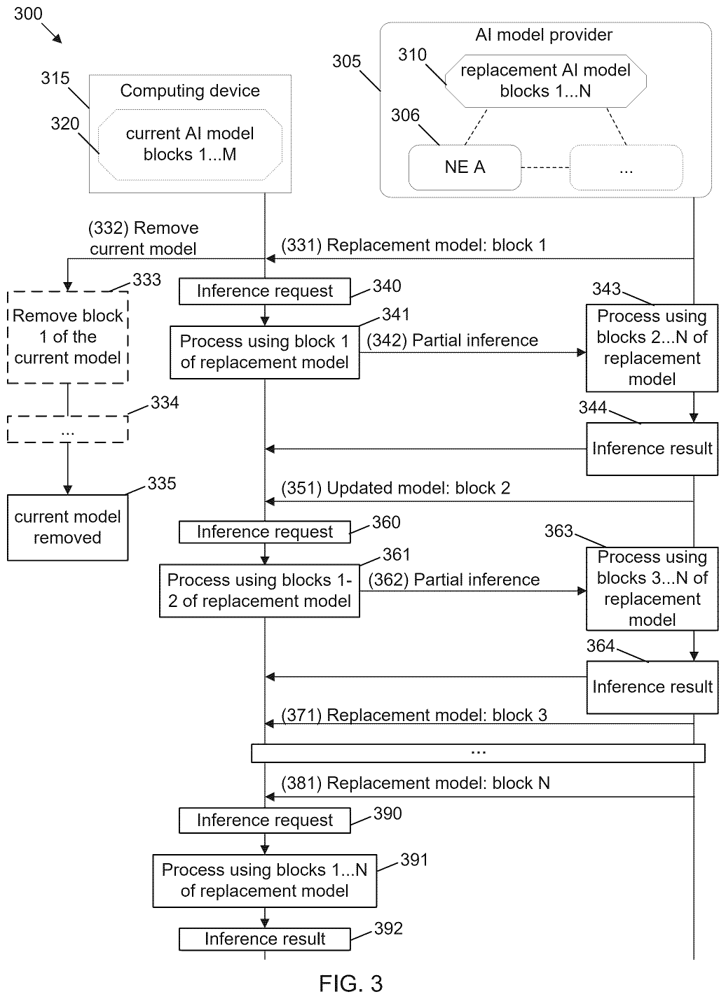

FIG. 3 shows a call diagram of an embodiment of a method 300 of inference during the provision or download of a replacement AI model 310 to a computing device 315 having current AI model 320 thereat, or during obtaining by the computing device 315 the replacement AI model 310. The replacement AI model 310has 1 to N blocks and the current AI model 320has 1 to M blocks.

The AI model provider 305 has (e.g., access to) all blocks of the replacement AI model 310. The AI model provider 305 may be communicatively coupled to one or more network element, such as network element (NE) A 306, each of which may be in communication with each other.

The AI model provider 305 provides (e.g., sends) first block 331 of the replacement AI model 310 to the computing device 315. Conversely, the computing device 315 obtains a first replacement block 331 from the AI model provider 315. In response to receiving the first block 331 of replacement AI model 310, the removing 332 of the current AI model 320 from the computing device 315 is initiated. The removing 332 of the current AI model 320 may include step 333 of removing the first block of the current AI model, any additional one or more step 334 of (e.g., sequentially, or correspondingly with the received blocks, as described elsewhere herein) removing any other blocks of the current AI model, until all blocks are removed at step 335.

After the first block 331 of the replacement AI model 310 is received at the computing device 315, the computing device requires inference and produces (e.g., generates, enters, receives via a user input) a first inference request having a first inference request 340. At step 341, the first inference request 340 is processed at the computing device 315 using the first received block 331 of the replacement AI model 310 to produce patrial inference 342. The partial inference 342 is provided to the AI model provider 305 for processing using all subsequent blocks of the replacement AI model. At step 343, the AI model provider processes the received partial inference 342 using blocks 2 to N of the replacement AI model to produce a first inference result 344 to the first inference request 340. The AI model provider provides the first inference result 344 to the computing device 315.

The AI model provider 305 provides (e.g., sends) a second block 351 of the replacement AI model 310 to the computing device 315. After the second block 351 of the replacement AI model 310 is received at the computing device 315, the computing device requires inference and produces (e.g., generates, enters, receives via a user input) a second inference request having a second inference request 360. At step 361, the second inference request 360 is processed at the computing device 315 using the first received block 331 and the second received block 351 of the replacement AI model 310 to produce respective patrial inference 362. The partial inference 362 is provided to the AI model provider 305 for processing using all subsequent blocks of the replacement AI model. At step 363, the AI model provider processes the received partial inference 362 using blocks 3 to N of the replacement AI model to produce a second inference result 364 to the second inference request 360. The AI model provider provides the second inference result 364 to the computing device 315.

Similarly to the above, the computing device 315 may continue receiving subsequent blocks of the replacement AI model 310 (e.g., one block at a time) from the AI model provider 305 until all blocks 1 to N are received at the computing device 315. At step 391, a subsequent inference request having a respective inference request 390 may be processed at the computing device 315 using all received blocks 1 to N of the replacement AI model 310 to output a respective inference result 392 at the computing device 315.

In embodiments, a group of remaining replacement blocks, absent from a set of replacement blocks already at the computing device, may be obtained at the computing device or provided to the computing device by the AI model provider or an associated network element thereof, to form the sequence of replacement blocks at the computing device. At this point, the inference request may be processed fully at the computing device using the sequence of replacement blocks threat.

In embodiments, an inference request is processed at the computing device using a set of replacement blocks stored in the memory coupled to the computing device and including all received sequential replacement blocks 1 to n, where n is a positive integer, of the replacement AI model having the sequence of replacement blocks 1 to N blocks, where N is a positive integer, starting with the first replacement block (i.e., block 1, input block) of the replacement AI model. The first (e.g., input) replacement block may be obtained to replace a first (e.g., input) current block at the computing device. Processing the inference request at the computing device using the received first replacement block and, if available, any other sequential subsequent one or more replacement block of the replacement AI model, collectively with the first replacement block forming the set of replacement blocks, advantageously facilitates privacy protection of the inference request and input data and/or features thereof by circumventing sending it to the AI model provider (or its associated network element) and further circumvents potentially high communication cost that may be associated with such sending.

The output (i.e., partial inference) of processing the inference request using blocks 1 to n at the computing device, is provided (e.g., sent, transmitted) to the AI model provider, or an associated network element thereof having the subsequent n+1 block and, if available, any other sequential subsequent one or more block of the replacement AI model blocks n+2 to N, collectively forming a group of remaining replacement blocks from among the sequence of replacement blocks of the replacement AI model that are not part of the set of replacement blocks provided to or obtained by the computing device, for further processing to obtain (e.g., output) a respective partial inference or, where all subsequent blocks n+1 to N are available, an inference result to the inference request. If the partial inference is provided to the AI model provider, the AI model provider may process the received partial inference, provided thereto, using the group of remaining replacement blocks to obtain an inference result.

If the partial inference is provided to an associated network element that has access to some but not all replacement blocks n+1 to N of the sequence of replacement blocks, then such network element outputs or obtains a respective partial inference using subsequent sequential blocks that are accessible to it and provides it for further processing to an entity having access to at least a subsequent sequential block of the sequence of replacement blocks, which may be the computing device, the AI model provider, or another associated network element. If the associated network element has access to all blocks of blocks n+1 to N of the replacement AI model, then it may output the inference result and provide it to the computing device, e.g., directly or indirectly via another one or more associated network element or the AI model provider. The inference result may be provided to or conversely obtained at the computing device from the AI model provider (e.g., directly or via an associated network element such as a base station).

In embodiments, the partial inference (i.e., output of any block except the last or output replacement block N) and/or the inference result may be suitably processed (e.g., encrypted, encoded, compressed) at the providing entity (e.g., computing device, AI model provider, network element) before being provided to a receiving entity (e.g., the computing device, AI model provider, or associated network element) for example, to limit the size thereof, to provide privacy protection thereof, and/or to comply with any applicable network protocols.

In embodiments, processing of an inference request using the set of replacement blocks of the replacement AI model received at the computing device may be concurrent with receiving another one or more block of the replacement AI model at the computing device.

In embodiments, the AI model provider may include a network element (NE), such as a base station (BS), having access to the sequence of replacement blocks. In such cases providing the partial inference to the AI model provider may include providing the partial inference to the NE.

The NE may have (e.g., access to or thereat) a group of remaining replacement blocks of the replacement AI model that are not part of the set of replacement blocks of the replacement AI model at the UE. In such case, the NE may obtain (e.g., compute) an inference result using the group of remaining replacement blocks to obtain respective inference result.

The AI model provider may include or may be communicatively coupled to more than one NE, such as a BS, each of which may have access to (i.e., the sequence of) replacement blocks of the replacement AI model. In such case, a computing device may obtain the set of replacement blocks from a first NE, provide partial inference obtained by processing an inference request using the set to a second NE for processing the partial inference using the group of remaining replacement blocks at the second NE to obtain an inference result.

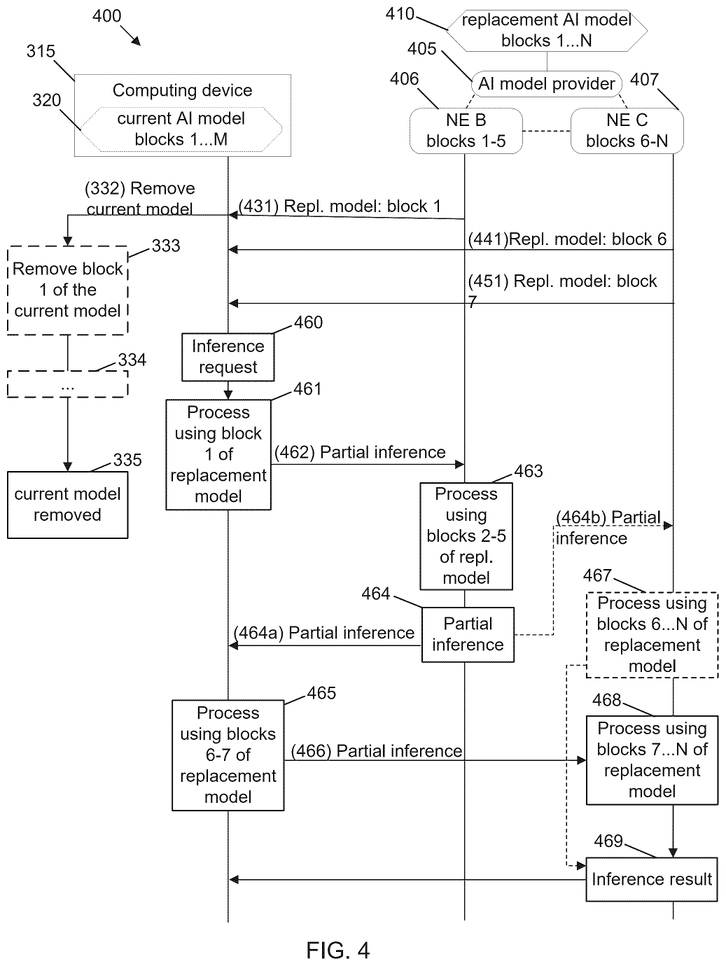

FIG. 4 illustrates a method 400 of inference during the provision or download of a replacement AI model 410 to a computing device 315 having current AI model 320 thereat, or during obtaining by the computing device 315 the replacement AI model 410. The replacement AI model 410 has 1 to N blocks and the current AI model 320 has 1 to M blocks.

The AI model provider 405 has (e.g., access to) all blocks of the replacement AI model 410. The AI model provider 405 is communicatively coupled to network element B 406 having blocks 1 to 5 of the replacement AI model 410 and network element C 407 having blocks 6 to N of the replacement AI model 410.

The network element B 406 provides (e.g., sends, transmits) a first block 431 of the replacement AI model 410 to the computing device 315. Conversely, the computing device 315 obtains the first replacement block 431 from the network element B 406. In response to obtaining or receiving the first block 431 of replacement AI model 410, the removing 332 of the current AI model 320 from the computing device 315 is initiated. The removing 332 of the current AI model 320 may include step 333 of removing the first block of the current AI model, any additional one or more step 334 of (e.g., sequentially, or correspondingly with the received blocks, as described elsewhere herein) removing any other blocks of the current AI model, until all blocks are removed at step 335.

The network element C 407 provides (e.g., sends, transmits) a sixth block 441 and seventh block 451 of the replacement AI model 410 to the computing device 315. Conversely, the computing device 315 obtains the sixth block 441 and seventh block 451 of the replacement AI model 410 from the network element C 407.

After the first block 431, the sixth block 441 and the seventh block 451 of the replacement AI model 410 are received at or obtained by the computing device 315, the computing device requires inference and produces (e.g., generates, enters, receives via a user input) a first inference request having a first inference request 460. At step 461, the first inference request 460 is processed at the computing device 315 using the first block 431 of the replacement AI model 410 to produce patrial inference 462. The partial inference 462 is provided to or obtained by the network element B 406 for processing 463 using subsequent blocks 2-5 thereat to obtain respective (e.g., second) the partial inference 464 that may be provided to or received by 464a the computing device 315. Alternatively, the respective partial inference 464 may be provided to or received by 464b the network element C 407.

If the respective partial inference 464 is provided to or received by 464a the computing device 315, it is processed 465 at the computing device 315 using subsequent sixth block 441 and seventh block 451 of the replacement AI model to obtain a respective (e.g., third) partial inference 466. The respective partial inference 466 is provided to or received by the network element C 407 for further processing using subsequent blocks 7 to N of the replacement AI model 410 to obtain inference result 469.

If the respective partial inference 464 is provided to or received by 464b the network element C 407, it is processed 467 at the network element C 407 using all subsequent blocks 6 to N of the replacement AI model 410 to obtain the inference result 469.

The inference result 469 is provided by the network element C 407 to the computing device 315. Conversely, the computing device 315 obtains the inference result 469 from the network element C 407. In some cases, the network element C 407 and the network element B 406 may be configured to sync and/or share data, such as respective partial inference(s) and/or the inference result(s). Such configuration of the network elements is advantageous in case one or more of the computing device and network elements are mobile. For example, if the computing device moved outside of communication range of the network element C 407, the network element C 407 may share the inference result 469 with the network element B 406 which can then provide it to the computing device 315.

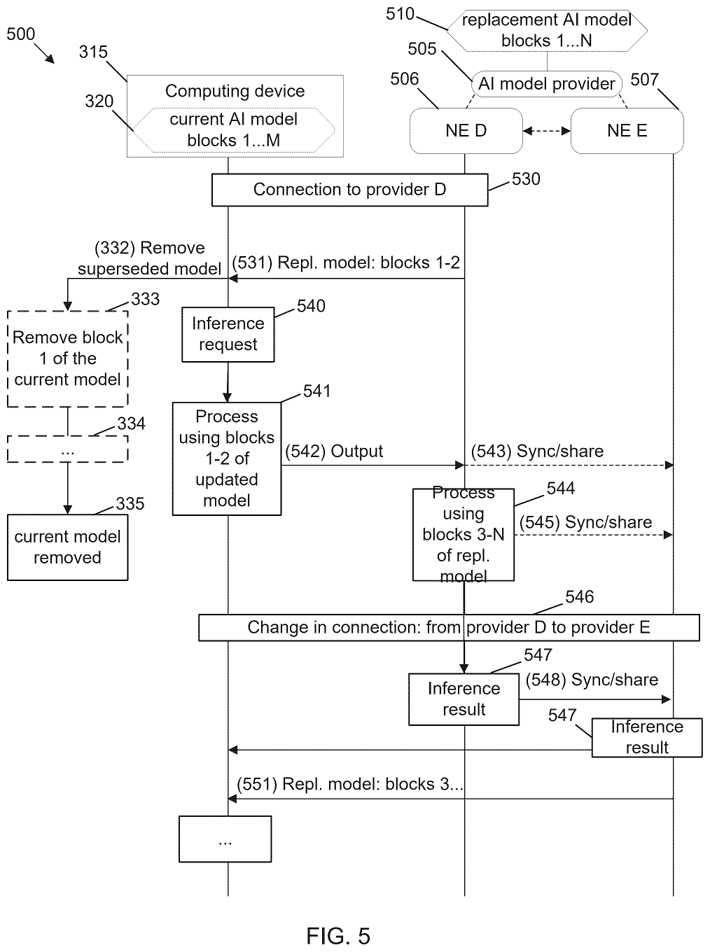

FIG. 5 illustrates a method 500 of inference during the provision or download of a replacement AI model 510 to a computing device 315 having current AI model 320 thereat or during obtaining by the computing device 315 the replacement AI model 510. The replacement AI model 510 has 1 to N blocks and the current AI model 320 has 1 to M blocks.

The AI model provider 505 has (e.g., access to) all blocks of the replacement AI model 510. The AI model provider 505 is communicatively coupled to network element D 506, which may be a BS, and network element E 507, which may be another BS, that are configured to share or sync inference outputs (e.g., partial inference, inference results). Before receiving or downloading any block(s) of the replacement AI model 510, the computing device 315 is within communication range of the network element D 506.

The network element D 506 provides 531 (e.g., sends, transmits) a first block and a second block of the replacement AI model 510 to the computing device 315. Conversely, the computing device 315 obtains the first block and the second block of the replacement AI model 510 from the network element D 506. In response to receiving at least the first block of the replacement AI model 510, the removing 332 of the current AI model 320 from the computing device 315 is initiated. The removing 332 of the current AI model 320 may include step 333 of removing the first block of the current AI model, any additional one or more step 334 of (e.g., sequentially, or correspondingly with the received blocks, as described elsewhere herein) removing any other blocks of the current AI model, until all blocks are removed at step 335.

After the first and second blocks of the replacement AI model 410 are received at or obtained by 531 the computing device 315, the computing device requires inference and produces (e.g., generates, enters, receives via a user input) a first inference request having a first inference request 540. At step 541, the first inference request 540 is processed at the computing device 315 using the first and second received blocks of the replacement AI model 510 to produce respective (e.g., first) patrial inference 542. The respective partial inference 542 is provided by the computing device to the network element D 506. Conversely, the network element D 506 obtains the partial inference 542 from the computing device 315. The network element D 506 may share 543 respective partial inference 542 with the network element E 507.

The network element D 506 processes 544 the received respective partial inference 542 using all subsequent blocks 3 to N to obtain inference result 547. At any point during processing 544, the network element D 506 may share 545 any one or more respective partial inference throughout the processing 544 with the network element E 507. At some point during processing 544, the computing device 315 moves outside of the range of communication with network element D 506 and a change 546 occurs in its connection from the network element D 506 to the network element E 507. The network element D 506 shares the obtained inference result 547 with network element E 507 which provides the inference result 547 to the computing device 315. Conversely, the computing device 315 obtain the inference result 547 from the network element E 507.

In subsequent steps, including step 551, subsequent blocks 3 to N of the replacement AI model 510 are provided to (or conversely obtained by) the computing device via network element E 507 and/or network element D 506 depending on the particular network element the computing device is communicatively connected to for respective receiving of block(s).

In embodiments, the AI model provider may be configured to validate performance of the replacement AI model while it is being downloaded at the computing device. The AI model provider may have access to the current AI model thereat and may compare the performance of the replacement AI model being downloaded at the EU against the performance of the current AI model accessible to the AI model provider, against the predetermined performance metric, against a key performance indicator, or a combination thereof.

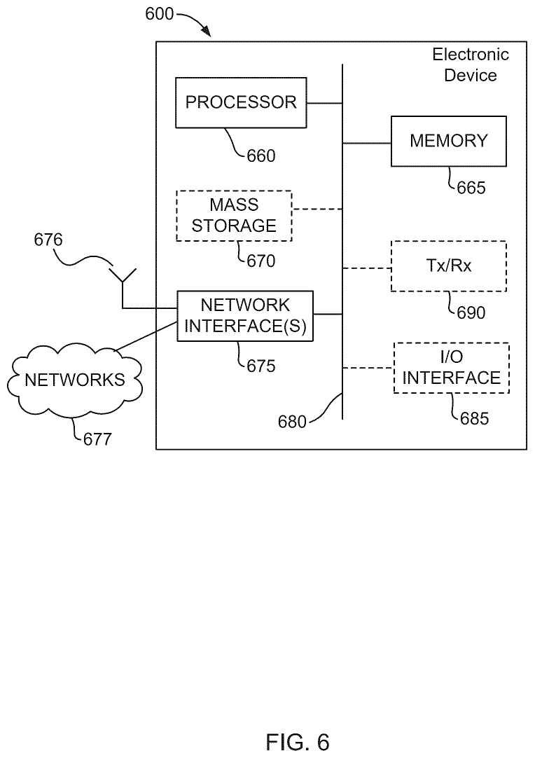

FIG. 6 shows a schematic diagram of an electronic device 600 that may perform any or all of the operations of the above methods and features explicitly or implicitly described herein, according to different embodiments of the present disclosure. For example, a computer equipped with network function may be configured as electronic device 600. The electronic device 600 may be used to implement the methods and systems described herein.

As shown, the electronic device 600 may include at least one processor 660, such as a Central Processing Unit (CPU) or specialized processors such as a Graphics Processing Unit (GPU), a Neural Processing Unit (NPU) or other such processor unit, memory 665, network interface 675, and a bi-directional bus 680 to communicatively couple the components of electronic device 600. The at least one processor 660 may be operatively coupled to a caching server. Electronic device 600 may also optionally include non-transitory mass storage 670, an I/O interface 685, and a transceiver 690. According to certain embodiments, any or all of the depicted elements may be utilized, or only a subset of the elements. Further, the electronic device 600 may contain multiple instances of certain elements, such as multiple processors, memories, or transceivers. Also, elements of the hardware device may be directly coupled to other elements without the bi-directional bus 680. Additionally or alternatively to a processor and memory, other electronics, such as integrated circuits, may be employed for performing the required logical operations.

The memory 665 may include any type of tangible, non-transitory memory such as static random access memory (SRAM), dynamic random access memory (DRAM), synchronous DRAM (SDRAM), read-only memory (ROM), any combination of such, or the like. The memory 665 in communication with the at least one processor 660 may have stored thereon a set of counters or slots for such set of counters or both. The mass storage element 670 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 665 or mass storage 670 may have recorded thereon statements and instructions executable by the at least one processor 660 for performing any of the aforementioned method operations described above.

Network interface 675 may include at least one of a wired network interface and a wireless network interface. The network interface 675 may include a wired network interface to connect to a communication network 677 and may also include a radio access network interface 676 for connecting to the communication network or other network elements over a radio link. The network interface 675 enables the electronic device 600 to communicate with remote entities such as those connected to the communication network 677.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A method comprising:
at a computing device having stored thereat a current artificial intelligence (AI) model having a sequence of current blocks stored in a memory coupled to the computing device:
obtaining, from an AI model provider having a replacement AI model that includes a sequence of replacement blocks:
a set of replacement blocks from among the sequence of replacement blocks, the set of replacement blocks having one or more replacement block;
storing the set of replacement blocks in the memory;
deleting from the memory at least one current block;
obtaining an inference request;
processing the inference request using the set of replacement blocks to obtain a partial inference; and
providing the partial inference to the AI model provider.

2. The method of claim 1, further comprising obtaining from the AI model provider an inference result obtained by processing the partial inference using a group of remaining replacement blocks comprising all the replacement blocks of the sequence of replacement blocks that are not part of the set of replacement blocks.

3. The method of claim 1, wherein:
the AI model provider includes a base station (BS) having access to the sequence of replacement blocks; and
providing the partial inference to the AI model provider includes providing the partial inference to the BS.

4. The method of claim 3, wherein the BS has a group of remaining replacement blocks, the remaining replacement blocks comprising all the replacement blocks of the sequence of replacement blocks that are not part of the set of replacement blocks, the method further comprising the BS computing the inference result using the group of remaining replacement blocks.

5. The method of claim 3, wherein:
the BS is a first BS;
the AI model provider includes a second BS having access to the sequence of replacement blocks;
obtaining, from the AI model provider, the set of replacement blocks includes obtaining the set of replacement blocks from the first BS; and
providing the partial inference to the AI model provider includes providing the partial inference to the second BS.

6. The method of claim 1, wherein:
the sequence of current blocks includes a current input block; and
obtaining the set of replacement blocks includes obtaining a replacement input block to replace the current input block.

7. The method of claim 1, further comprising:
obtaining, at the computing device, a group of remaining replacement blocks of the replacement AI model, the group of remaining replacement blocks comprising all the replacement blocks of the sequence of replacement blocks that are not part of the set of replacement blocks;
processing, at the computing device, a further inference request using the set of replacement blocks and the group of remaining replacement blocks of the replacement AI model to obtain a further inference result to the further inference request.

8. The method of claim 1, wherein:
the computing device is one of: an edge device, a physical computing device, a virtual computing device, a target agent, an end user device, or a combination thereof;
obtaining the inference request includes obtaining the inference request at, respectively, the edge device, the physical computing device, the virtual computing device, the target agent, the end user device, or the combination thereof.

9. The method of claim 1, wherein:
the AI model provider is one of: a base station (BS), a datacenter, an AI model providing service, an AI model training factory, another edge device, another physical computing device, another virtual computing device, another target agent, another end user device, or a combination thereof; and
providing the partial inference to the AI model provider includes providing the partial inference to, respectively, the base station (BS), the datacenter, the AI model providing service, the AI model training factory, the other edge device, the other physical computing device, the other virtual computing device, the other target agent, the other end user device, or the combination thereof.

10. The method of claim 1, wherein the replacement AI model is one of: an updated version of the current AI model, a new AI model for replacing the current AI model, or a copy of the current AI model for replacing an unusable copy of the current AI model.

11. The method of claim 1, further comprising one or more of:
receiving, at the computing device, from the AI model provider, an indication of the replacement AI model; and
providing, by the computing device to the AI model provider, based on the indication, a request requesting the replacement AI model.

12. A method comprising:
by an artificial intelligence (AI) model provider having a replacement AI model that includes a sequence of replacement blocks:
providing a set of replacement blocks from among the sequence of replacement blocks to a computing device having stored thereat a current AI model having a sequence of current blocks stored in a memory coupled to the computing device, the set of replacement blocks having one or more replacement block, all the replacement blocks of the sequence of replacement blocks that are not part of the set of replacement blocks forming a group of remaining replacement blocks having one or more remaining replacement block;
obtaining, from the computing device, a partial inference obtained based on the set of replacement blocks; and
processing the partial inference using the group of remaining replacement blocks, to obtain an inference result.

13. The method of claim 12, further comprising the AI model provider providing the inference result to the computing device.

14. The method of claim 12, wherein:
the AI model provider includes a base station (BS) having access to the sequence of replacement blocks; and
obtaining, from the computing device, by the AI model provider includes obtaining, by the BS, the partial inference.

15. The method of claim 14, wherein the BS has the group of remaining replacement blocks, the method further comprising the BS computing the inference result using the group of remaining replacement blocks.

16. The method of claim 14, wherein:
the BS is a first BS;
the AI model provider includes a second BS having access to the sequence of replacement blocks;
providing, by the AI model provider, the set of replacement blocks includes the first BS providing the set of replacement blocks; and
obtaining the partial inference by the AI model provider includes receiving, by the second BS, the partial inference for processing the partial inference using the group of remaining replacement blocks to obtain the inference result.

17. The method of claim 12, further comprising:
providing, by the AI model provider to the computing device, the group of remaining replacement blocks of the replacement AI model.

18. A system comprising:
a computing device having stored thereat a current artificial intelligence (AI) model having a sequence of current blocks stored in a memory coupled to the computing device; and
an AI model provider having a replacement AI model that includes a sequence of replacement blocks the AI model provider configured to:
provide a set of replacement blocks from among the sequence of replacement blocks to the computing device, the set of replacement blocks having one or more replacement block, all the replacement blocks of the sequence of replacement blocks that are not part of the set of replacement blocks forming a group of remaining replacement blocks having one or more remaining replacement block;
obtain, from the computing device, a partial inference obtained by processing an inference request at the computing device using the set of replacement blocks; and
process the partial inference using the group of remaining replacement blocks, to obtain an inference result.

19. The system of claim 18, wherein, at any time:
a size of the memory occupied by:
the received set of replacement blocks of the replacement AI model; and
all current blocks of the current AI model remaining in the memory,
is less than a combined total size of:
a size of the sequence of replacement blocks of the replacement AI model; and
a size of the sequence of current blocks of the current AI model.

20. The system of claim 18, the AI model provider further comprising a base station (BS) having access to the sequence of replacement blocks, wherein providing the partial inference to the AI model provider includes providing the partial inference to the BS.
